(19) United States
(12) Patent Application Publication
(10) Pub. No.: US 2017/0055501 A1
(43) Pub. Date: Mar. 2, 2017

(54) Honey Frame Hanger

(71) Applicants: Joseph D. Forte, Nashville, TN (US); William D. Forte, Nashville, TN (US)

(72) Inventors: Joseph D. Forte, Nashville, TN (US); William D. Forte, Nashville, TN (US)

(21) Appl. No.: 15/270,073

(22) Filed: Sep. 20, 2016

Related U.S. Application Data
(60) Provisional application No. 62/230,582, filed on Jun. 11, 2015.

(51) Int. Cl. A01K 47/02

(52) U.S. Cl. CPC A01K 47/02

(57) ABSTRACT

Through the years honeycomb frames have been pulled from the hive during inspection and placed on a frame perch available from a supplier. This frame perch is directly attached to the hive body that is being inspected. If the beekeeper does not have a perch the honeycomb frame is placed on the ground. Neither of these methods is practical for the hobby beekeeper with two or more hives. Our invention aids the beekeeper by providing a convenient place to temporarily hold honey frames that are being inspected without the hassle of moving the “frame perch” from one hive to another. Our frame holder would be located to the rear of the hive in order service multiple hives.

### BACKGROUND OF INVENTION

There is no comparable frame hanger on the market that is independent of hive box that temporarily stores honey frames during hive inspection. The hanger is staked to the ground with foot pressure near the bee hive for a convenient way to store one or more honey frames from a hive box(es) for the beekeeper to determine their future use. It can be staked in one place to service up to four hives.

### BRIEF SUMMARY

This hanger makes obsolete a commercial perch that hangs on the top of the hive box and is very awkward to manage during inspection.

### BRIEF DESCRIPTION OF DRAWING

FIG. 1A shows the elevation view of the hanger as it would be when staked to the ground. FIG. 1B shows a top view of the arms of the hanger with the top of the honey frame, shown in broken lines, hanging from them. FIG. 1C shows how the arms are attached to the support bars. FIG. 1D shows a section cut through the arms with the honey frame, shown in broken lines, hanging from them.

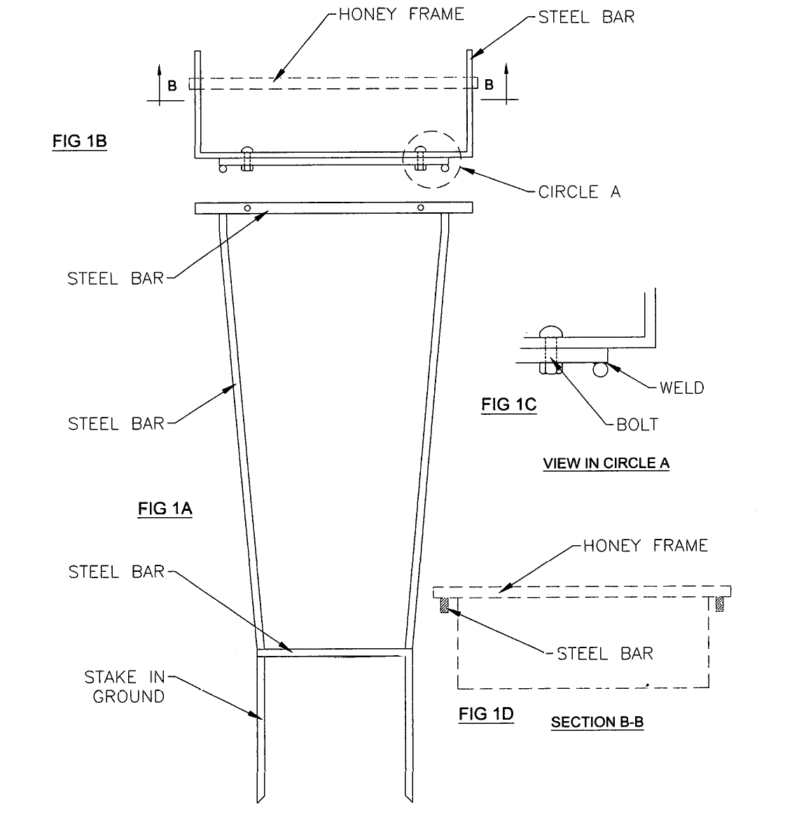

### DETAILED DESCRIPTION OF INVENTION

Frames of honeycomb are routinely inspected by the beekeeper to determine their contents. A hive box could contain up to ten frames. The contents of each frame needs to be observed at times to ascertain the overall health of the colony. To properly inspect the hive one or more frames need to be removed and temporarily set aside on the frame holder in order to have a visual of the remaining frames. This invention offers the beekeeper a convenient way to remove and store the inspected frames of honeycomb.

1. The claim for this invention is that there is no other honey frame holder on the market that is independent of (not hanging directly on) the hive body to temporarily hold honeycomb frames during the inspection process.
